(19) United States
(12) Patent Application Publication
(10) Pub. No.: US 2010/0153002 A1
(43) Pub. Date: Jun. 17, 2010

(54) ROUTE GUIDANCE SYSTEM AND METHOD FOR EMERGENCY VEHICLE USING TELEMATICS

(75) Inventors: Sang Ho LEE, Daegu (KR); Kyu Hyung Kim, Daegu (KR); Gwang Su Kim, Daejeon (KR); Ho Geun Lee, Daejeon (KR); Jang Sik Bae, Daejeon (KR); Young Kyu Jeong, Gyeongsangnam-do (KR); Joung Sik Kim, Daegu (KR); Jin Sam Kim, Daejeon (KR); Ji Sung Jung, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/506,715

(22) Filed: Jul. 21, 2009

(30) Foreign Application Priority Data
Dec. 16, 2008 (KR) 10-2008-0127874

(51) Int. Cl. G01C 21/36; G08G 1/087

(52) U.S. Cl. 701/201

(57) ABSTRACT

Provided are a route guidance system and method for emergency vehicle using telematics. The route guidance system includes an instruction station, a vehicle telematics and a traffic signal controller. The instruction station sends destination information to an emergency vehicle for dispatch due to an occurrence of an emergency circumstance. The vehicle telematics is attached to the emergency vehicle, and searches a plurality of travel routes on the basis of the destination information to provide the shortest travel route. The traffic signal controller controls a corresponding traffic signal on the travel route before the emergency vehicle approaches on the basis of travel information sent from the vehicle telematics.

### CROSS-REFERENCE TO RELATED APPLICATIONS

This application claims priority under 35 U.S.C. §119 to Korean Patent Application No. 10-2008-0127874 filed on Dec. 16, 2008, in the Korean Intellectual Property Office, the disclosure of which is incorporated herein by reference in its entirety.

### TECHNICAL FIELD

The following disclosure relates to a route guidance system and method for an emergency vehicle using telematics, and in particular, to a route guidance system and method, which ensure the mobility of emergency vehicles by using telematics.

### BACKGROUND

Recently, the increase in the number of vehicles on the road can be described as explosive as it is compared to those of roadways and traffic facilities.

Accordingly, traffic is extremely congested on city streets, rural roads and highways, obstructing passage of emergency vehicles in their endeavors to save property and human lives. The obstruction of such vehicles impedes rescue efforts and may cause unimaginable amounts of damage.

To solve these problems, a related art traffic control method has been proposed, which sends the destination of a dispatched emergency vehicle to an information center and extracts the shortest route, along which traffic lights are controlled, in order to ensure fast arrival. Another related art traffic control method has been proposed, which recognizes the position of a dispatched emergency vehicle with a Radio Frequency Identification (RFID) tag, while controlling traffic lights.

However, the related art traffic control method that extracts the shortest route while controlling traffic lights may not properly reflect traffic conditions which is changing frequently.

Moreover, the related art traffic control method that recognizes the position of the emergency vehicle with the RFID tag while controlling traffic lights involves high additional costs because many RFID readers must be installed to provide the added positioning service.

### SUMMARY

In one general aspect of the present invention, a route guidance system for emergency vehicle using telematics includes: an instruction station sending destination information to an emergency vehicle for dispatch due to an occurrence of an emergency circumstance; a vehicle telematics, which is attached to the emergency vehicle, searching a plurality of travel routes on the basis of the destination information to provide the shortest travel route; and a traffic signal controller controlling a corresponding traffic signal on the travel route before the emergency vehicle approaches on the basis of travel information sent from the vehicle telematics.

In another general aspect, a route guidance method for emergency vehicle using telematics includes: checking if destination information comprising a dispatch request for an emergency vehicle is received, or if destination information is inputted from a driver, due to an occurrence of an emergency circumstance; searching a plurality of travel routes on the basis of the destination information according to Transport Protocol Expert Group (TPEG) to send travel information comprising the shortest travel route when the destination information is received or inputted; and controlling a corresponding traffic signal on the travel route before the emergency vehicle approaches on the basis of the travel information.

Other features and aspects will be apparent from the following detailed description, the drawings, and the claims.

### BRIEF DESCRIPTION OF THE DRAWINGS

FIG. 1 is a block diagram schematically illustrating the configuration of a route guidance system for emergency vehicle using telematics according to an exemplary embodiment of the present invention.

FIG. 2 is a flowchart illustrating the route guidance process of an emergency vehicle using telematics according to an exemplary embodiment.

FIG. 3 is a diagram illustrating the operation flow between the route guidance elements of an emergency vehicle according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

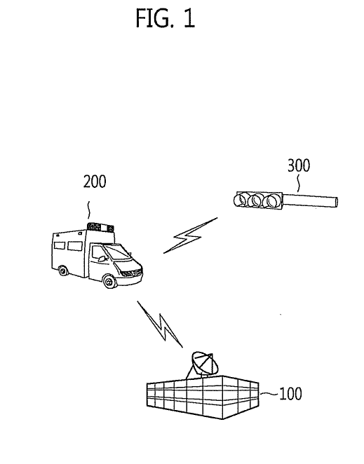

FIG. 1 is a block diagram schematically illustrating the configuration of a route guidance system for emergency vehicle using telematics according to an exemplary embodiment of the present invention.

Referring to FIG. 1, a route guidance system for emergency vehicle according to an exemplary embodiment includes an instruction station 100, a vehicle telematics 200, and a traffic signal controller 300.

The instruction station 100 sends destination information to a corresponding vehicle when an emergency vehicle is required to move due to an occurrence of an emergency circumstance. At this point, the instruction station 100 receives a request for the emergency vehicle from the National Police Agency, 119 Security Report Center, etc.

The vehicle telematics 200 is attached to the emergency vehicle, and searches travel routes on the basis of the destination information to provide the shortest travel route. At this point, the vehicle telematics 200 searches and set the shortest travel route according to TPEG that is provided from a TPEG service system (not shown).

Moreover, when changing a travel route, the vehicle telematics 200 searches again and sets the shortest travel route at the changing point.

The vehicle telematics 200 sends travel information as wireless information or RFID tag information to the traffic signal controller 300 of a corresponding traffic signal. The travel information comprises moving directions of the vehicle including left turn, straight, and right turn information, and vehicle registration information as an emergency vehicle.

The traffic signal controller 300 controls the corresponding traffic signal on the travel route before the emergency vehicle approaches, on the basis of the travel information sent from the vehicle telematics 200. At this point, the traffic signal controller 300 controls traffic lights according to whether the travel information includes the emergency-vehicle registration information.

An operation process according to an exemplary embodiment will be described with reference to the accompanying drawings as follows.

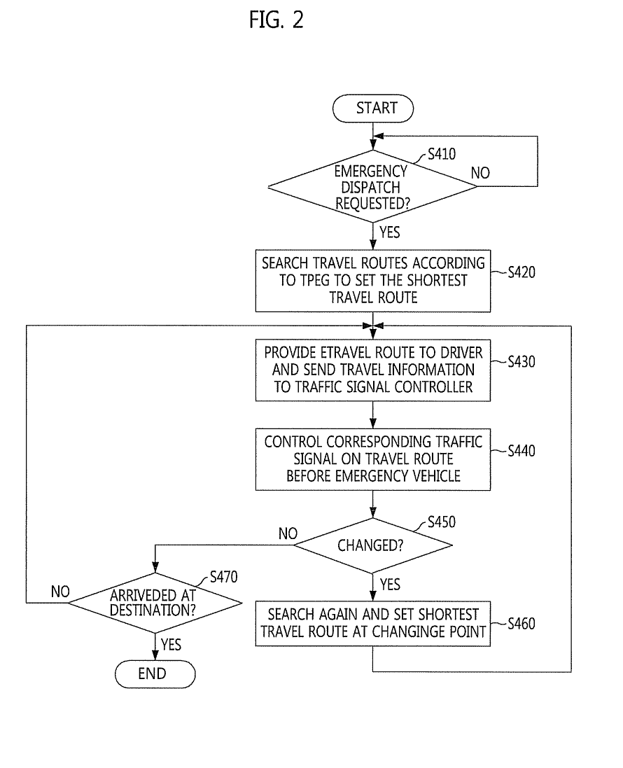

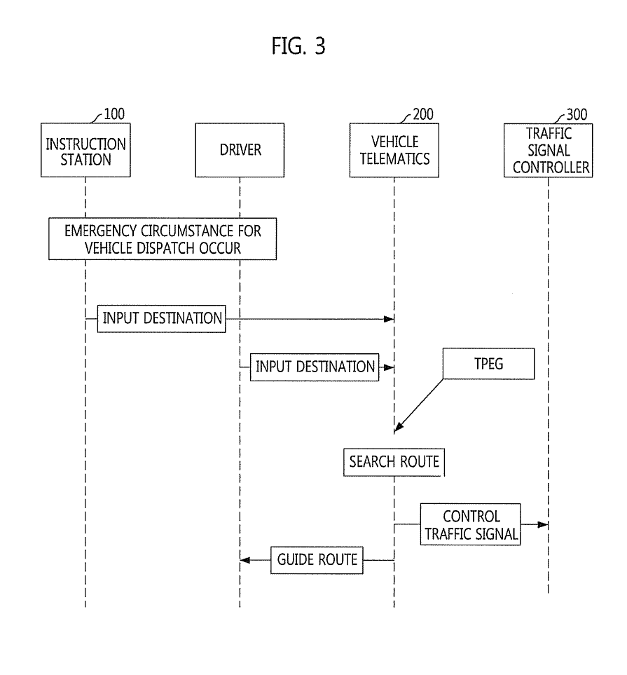

FIG. 2 is a flowchart illustrating the route guidance process of an emergency vehicle using telematics according to an exemplary embodiment. FIG. 3 is a diagram illustrating the operation flow between the route guidance elements of an emergency vehicle according to an exemplary embodiment.

Referring to FIGS. 2 and 3, when the National Police Agency or the 119 Security Report Center requests a dispatch of an emergency vehicle due to an occurrence of an emergency circumstance, the instruction station 100 sends destination information including a dispatch request to the emergency vehicle. At this point, the instruction station 100 sends the destination information to an emergency vehicle near the corresponding destination so as to arrive quickly.

Herein, the destination information includes Global Positioning System (GPS) coordinates for the determination of a corresponding position, a phone number and an address.

The vehicle telematics 200 checks whether the destination information including the dispatch request for the emergency vehicle is received from the instruction station 100 in step S410.

When the check result of step S410 shows that the destination information is received, the vehicle telematics 200 searches travel routes on the basis of the destination information according to the TPEG that is provided from the TPEG service system and decides the shortest travel route among the searched routes in step S420.

In step S410, the vehicle telematics 200 also checks whether the destination information is directly inputted from a driver according to the dispatch request for the emergency vehicle through a mobile terminal, etc. other than the instruction station 100.

Subsequently, the vehicle telematics 200 starts to provide the travel route to the driver, and, at the same time, the vehicle telematics 200 sends travel information as wireless information or RFID tag information to the traffic signal controller 300 of a corresponding traffic signal in step S430.

Herein, the travel information comprises moving directions of the vehicle including left turn, straight, and right turn information, and vehicle registration information as an emergency vehicle.

The traffic signal controller 300 receives the travel information, which is sent in step S430, and controls the corresponding traffic signal on the travel route before the emergency vehicle approaches, in step S440. The traffic signal controller 300 controls traffic lights according to whether the travel information includes the emergency-vehicle registration information.

Security for the emergency-vehicle registration information may be strengthened with an encryption code and the like, thereby preventing forgery and unauthorized use.

When the travel route is changed through a detour according to the TPEG in step S450, the vehicle telematics 200 searches again and sets the shortest travel route at the changing point in step S460.

Afterwards, the vehicle telematics 200 provides the changed travel route, which is set in step S460, to the driver and, at the same time, the vehicle telematics 200 sends travel information including the changed travel route to the traffic signal controller 300 in step S430.

Accordingly, the traffic signal controller 300 controls a traffic signal on the changed travel route included in the travel information that is received from the vehicle telematics 200 in step S440.

When the travel route need not to be changed in step S450, the vehicle telematics 200 determines whether the emergency vehicle is arrived at the corresponding destination, and ends the providing of the travel route if the emergency vehicle is arrived at the corresponding destination, in step S470.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A route guidance system for an emergency vehicle using telematics, the route guidance system comprising:
an instruction station sending destination information to an emergency vehicle for dispatch due to an occurrence of an emergency circumstance;
a vehicle telematics, which is attached to the emergency vehicle, searching a plurality of travel routes on the basis of the destination information to provide the shortest travel route; and
a traffic signal controller controlling a corresponding traffic signal on the travel route before the emergency vehicle approaches on the basis of travel information sent from the vehicle telematics.

2. The route guidance system of claim 1, wherein the destination information comprises GPS coordinates for a determination of a corresponding position, a phone number and an address.

3. The route guidance system of claim 1, wherein the travel information comprises moving directions of the emergency vehicle including left turn, straight, and right turn information.

4. The route guidance system of claim 3, wherein the travel information further comprises emergency-vehicle registration information.

5. The route guidance system of claim 1, wherein the vehicle telematics sends the travel information as wireless information or RFID tag information to the traffic signal controller of a corresponding traffic signal.

6. The route guidance system of claim 1, wherein the vehicle telematics searches and sets the shortest travel route according to Transport Protocol Expert Group (TPEG).

7. The route guidance system of claim 6, wherein the vehicle telematics searches again and sets the shortest travel route at a changing point when changing the travel route according to the TPEG.

8. The route guidance system of claim 1, wherein the traffic signal controller controls traffic lights according to whether the travel information comprises emergency-vehicle registration information.

9. A route guidance method for emergency vehicle using telematics, the route guidance method comprising:
checking if destination information comprising a dispatch request for an emergency vehicle is received, or if destination information is inputted from a driver, due to an occurrence of an emergency circumstance;
searching a plurality of travel routes on the basis of the destination information according to Transport Protocol Expert Group (TPEG) to send travel information comprising the shortest travel route when the destination information is received or inputted; and
controlling a corresponding traffic signal on the travel route before the emergency vehicle approaches on the basis of the travel information.

10. The route guidance method of claim 9, wherein the destination information comprises GPS coordinates for a determination of a corresponding position, a phone number and an address.

11. The route guidance method of claim 9, wherein the travel information comprises moving directions of the emergency vehicle including left turn, straight, and right turn information.

12. The route guidance method of claim 11, wherein the travel information further comprises emergency-vehicle registration information.

13. The route guidance method of claim 9, wherein the sending of the travel information comprises again searching and setting the shortest travel route at a change point when changing the travel route, according to the TPEG.

14. The route guidance method of claim 9, wherein the sending of travel information comprises sending the travel information as wireless information or RFID tag information to a traffic signal controller of a corresponding traffic signal.

15. The route guidance method of claim 9, wherein the controlling of a corresponding traffic signal comprises controlling traffic lights according to whether the travel information comprises emergency-vehicle registration information.
